(19) United States
(12) Patent Application Publication
(10) Pub. No.: US 2025/0358771 A1
(43) Pub. Date: Nov. 20, 2025

(54) CELL BARRING FOR OVER-THE-TOP POSITIONING

(71) Applicant: QUALCOMM Incorporated, San Diego, CA (US)

(72) Inventors: Mukesh KUMAR, Hyderabad (IN); Guttorm Ringstad OPSHAUG, Redwood City, CA (US); Arash MIRBAGHERI, San Diego, CA (US)

(21) Appl. No.: 18/668,500

(22) Filed: May 20, 2024

(51) Int. Cl. H04W 64/00; H04B 17/318; H04W 84/12

(52) U.S. Cl. CPC H04W 64/00; H04B 17/318; H04W 84/12

(57) ABSTRACT

Disclosed are techniques for communication. In an aspect, a user equipment (UE) transmits, to a location server, a first positioning request to obtain a position of the UE based on a first positioning procedure involving at least a serving cell of the UE, receives, from the location server, an error message indicating that the position of the UE is not available, and transmit, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a user equipment (UE) includes transmitting, to a location server, a first positioning request to obtain a position of the UE based on a first positioning procedure involving at least a serving cell of the UE; receiving, from the location server, an error message indicating that the position of the UE is not available; and transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

In an aspect, a user equipment (UE) includes one or more memories; one or more transceivers; and one or more processors communicatively coupled to the one or more memories and the one or more transceivers, the one or more processors, either alone or in combination, configured to: transmit, via the one or more transceivers, to a location server, a first positioning request to obtain a position of the UE based on a first positioning procedure involving at least a serving cell of the UE; receive, via the one or more transceivers, from the location server, an error message indicating that the position of the UE is not available; and transmit, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

In an aspect, a user equipment (UE) includes means for transmitting, to a location server, a first positioning request to obtain a position of the UE based on a first positioning procedure involving at least a serving cell of the UE; means for receiving, from the location server, an error message indicating that the position of the UE is not available; and means for transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

In an aspect, a non-transitory computer-readable medium stores computer-executable instructions that, when executed by a user equipment (UE), cause the UE to: transmit, to a location server, a first positioning request to obtain a position of the UE based on a first positioning procedure involving at least a serving cell of the UE; receive, from the location server, an error message indicating that the position of the UE is not available; and transmit, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates an example location services procedure, according to aspects of the disclosure.

FIG. 5A illustrates an example uplink enhanced cell identifier (E-CID) measurement procedure between a radio access network (RAN) node and a location server, according to aspects of the disclosure.

FIG. 5B illustrates an example Location Information Transfer operation for an E-CID method, according to aspects of the disclosure.

FIG. 6 is a diagram illustrating an example frame structure, according to aspects of the disclosure.

FIG. 7 is a diagram illustrating an example tracking reference signal (TRS) configuration, according to aspects of the disclosure.

FIG. 8 is a graph of an example channel energy response (CER) estimate, according to aspects of the disclosure.

FIG. 9 illustrates an example over-the-top (OTT)-based positioning procedure using TRS, according to aspects of the disclosure.

FIG. 10A illustrates an example master information block (MIB) containing the “cellBarred” IE, according to aspects of the disclosure.

FIG. 10B illustrates a portion of an example system information block (SIB) that includes a “cellReservedForOtherUse” flag, according to aspects of the disclosure.

FIG. 11 is a diagram 1100 illustrating an example of positioning uncertainty (PUNC) increasing with time, according to aspects of the disclosure.

FIG. 12 is a diagram illustrating relative positioning uncertainty propagation rates of different types of UE motion classifications, according to aspects of the disclosure.

FIGS. 13 and 14 illustrate example methods of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to wireless positioning. Some aspects more specifically relate to cell barring for positioning. In some examples, a location server can indicate how long before a user equipment (UE) may make a new positioning request (e.g., the UE must wait until it switches to a new serving cell, until a change in frequency, a change in network operator, and/or expiration of a timer). This may be a common rule for all positioning methods or may be specific to particular positioning methods. In some cases, positioning cell barring information may be broadcast within a system information block (SIB). In some cases, if, a UE may be restricted from sending new positioning requests until after a time duration T and a positioning uncertainty greater than a threshold. In some cases, the UE motion class may be used to determine the positioning uncertainty propagation rate. In some cases, a UE may use cell barring information to select another suitable cell within a threshold signal strength of the current serving cell.

Particular aspects of the subject matter described in this disclosure can be implemented to realize one or more of the following potential advantages. In some examples, by preventing the UE from repeatedly transmitting positioning requests to the location server, the described techniques can be used to reduce unnecessary signaling overhead.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

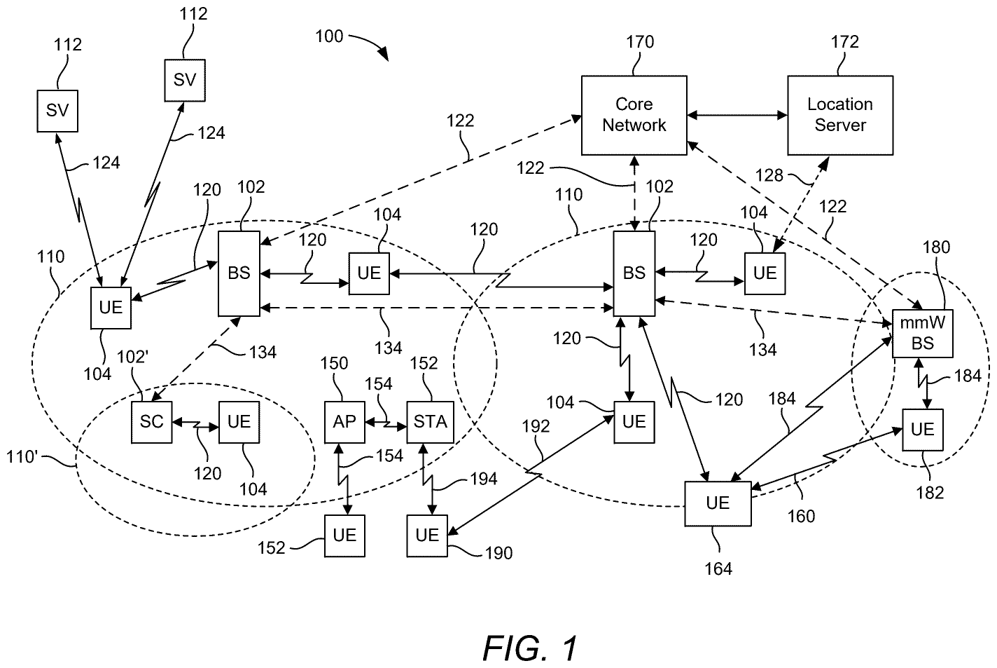

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHZ) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

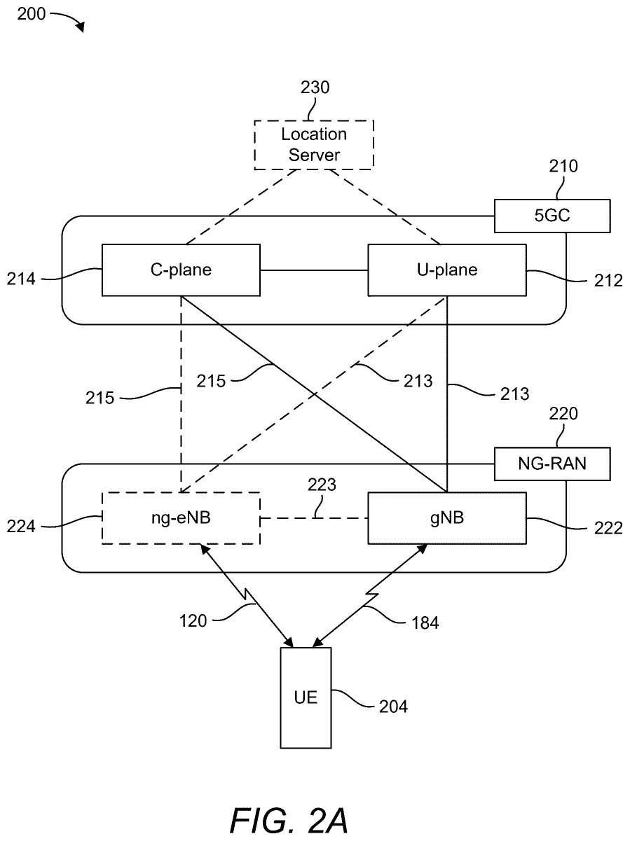

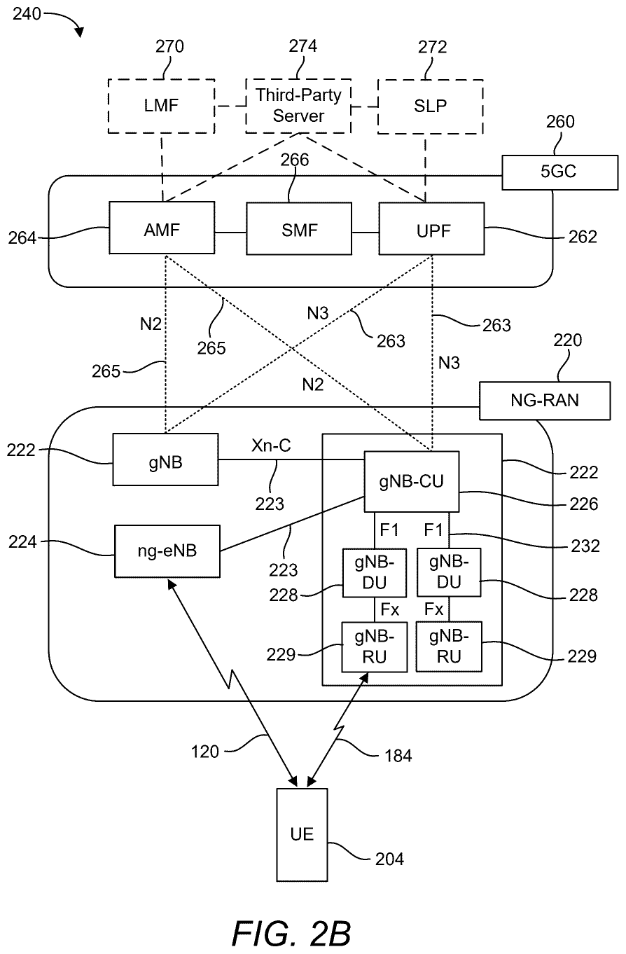

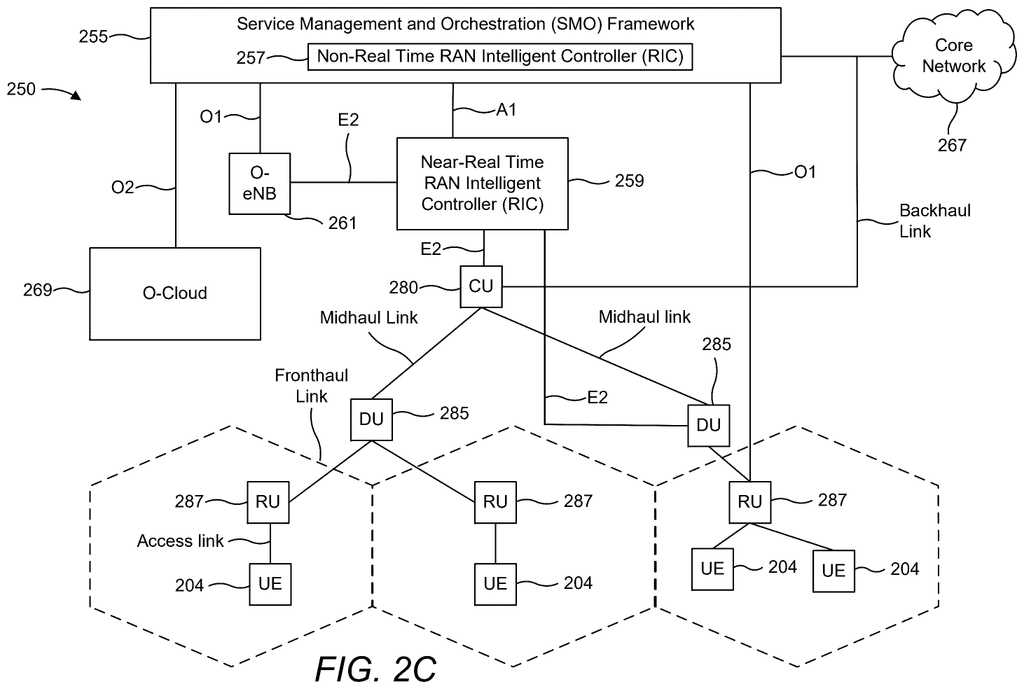

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUs) 287 (e.g., gNB-RUs 229) via respective fronthaul links. The RUs 287 may communicate with respective UEs 204 via one or more radio frequency (RF) access links. In some implementations, the UE 204 may be simultaneously served by multiple RUs 287.

Each of the units, i.e., the CUs 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUs 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

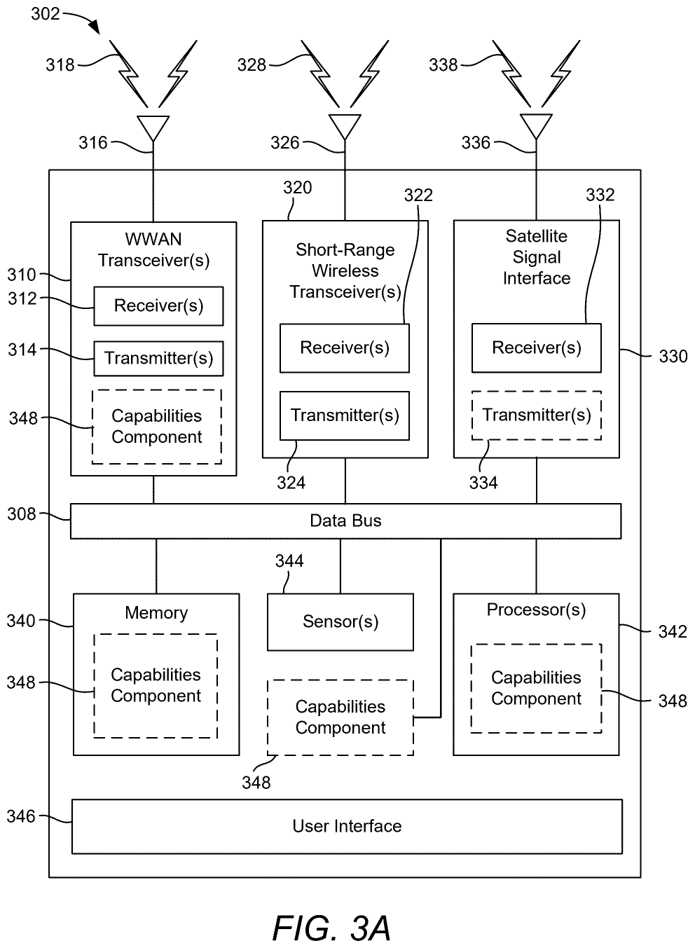

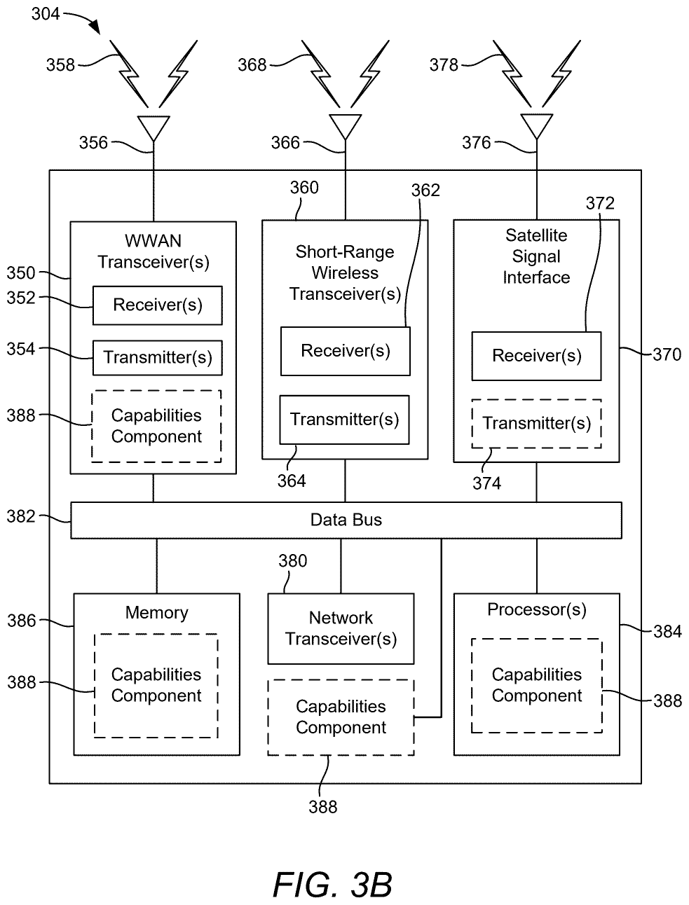

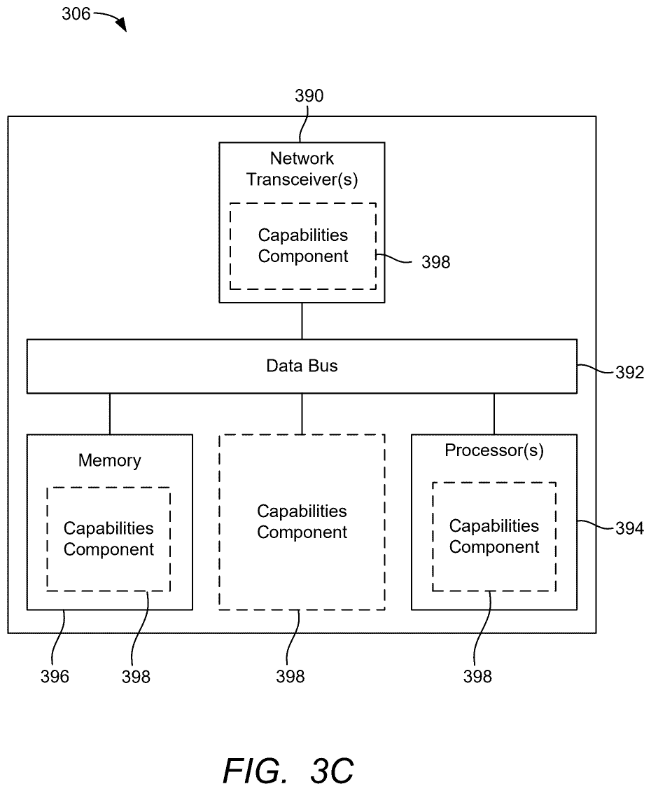

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 304 may be a terrestrial base station that may communicate with space vehicles (e.g., space vehicles 112) via the satellite signal interface 370. In other cases, the base station 304 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 302 and the base station 304, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include capabilities component 348, 388, and 398, respectively. The capabilities component 348, 388, and 398 may be hardware circuits that are part of or coupled to the processors 342, 384, and 394, respectively, that, when executed, cause the UE 302, the base station 304, and the network entity 306 to perform the functionality described herein. In other aspects, the capabilities component 348, 388, and 398 may be external to the processors 342, 384, and 394 (e.g., part of a modem processing system, integrated with another processing system, etc.). Alternatively, the capabilities component 348, 388, and 398 may be memory modules stored in the memories 340, 386, and 396, respectively, that, when executed by the processors 342, 384, and 394 (or a modem processing system, another processing system, etc.), cause the UE 302, the base station 304, and the network entity 306 to perform the functionality described herein. FIG. 3A illustrates possible locations of the capabilities component 348, which may be, for example, part of the one or more WWAN transceivers 310, the memory 340, the one or more processors 342, or any combination thereof, or may be a standalone component. FIG. 3B illustrates possible locations of the capabilities component 388, which may be, for example, part of the one or more WWAN transceivers 350, the memory 386, the one or more processors 384, or any combination thereof, or may be a standalone component. FIG. 3C illustrates possible locations of the capabilities component 398, which may be, for example, part of the one or more network transceivers 390, the memory 396, the one or more processors 394, or any combination thereof, or may be a standalone component.

The UE 302 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 304, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 308, 382, and 392, respectively. In an aspect, the data buses 308, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 342, 384, 394, the transceivers 310, 320, 350, and 360, the memories 340, 386, and 396, the capabilities component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as Wi-Fi).

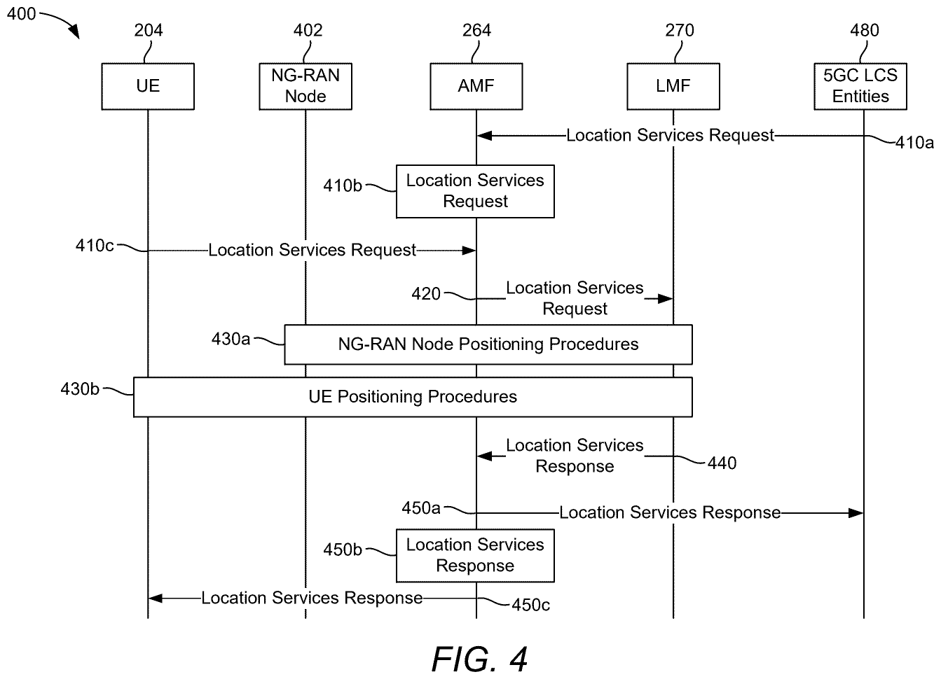

FIG. 4 illustrates an example location services procedure 400, according to aspects of the disclosure. The location services procedure 400 may be performed by a UE 204, an NG-RAN node 402 (e.g., gNB 222, gNB-CU 226, ng-eNB 224, or other node in the NG-RAN 220) in the NG-RAN 220, an AMF 264, an LMF 270, and a 5GC location services (LCS) entity 480 (e.g., any third-party application requesting the UE's 204 location, a public service access point (PSAP), an E-911 server, etc.).

A location services request to obtain the location of a target (i.e., UE 204) may be initiated by a 5GC LCS entity 480, the AMF 264 serving the UE 204, or the UE 204 itself. FIG. 4 illustrates these options as stages 410a, 410b, and 410c, respectively. Specifically, at stage 410a, a 5GC LCS entity 480 sends a location services request to the AMF 264. Alternatively, at stage 410b, the AMF 264 generates a location services request itself. Alternatively, at stage 410c, the UE 204 sends a location services request to the AMF 264.

Once the AMF 264 has received (or generated) a location services request, it forwards the location services request to the LMF 270 at stage 420. The LMF 270 then performs NG-RAN positioning procedures with the NG-RAN node 402 at stage 430a and UE positioning procedures with the UE 204 at stage 430b. The specific NG-RAN positioning procedures and UE positioning procedures may depend on the type(s) of positioning method(s) used to locate the UE 204, which may depend on the capabilities of the UE 204. The positioning method(s) may be downlink-based (e.g., LTE observed time difference of arrival (OTDOA), downlink time difference of arrival (DL-TDOA), downlink angle of departure (DL-AoD), etc.), uplink-based (e.g., uplink time difference of arrival (UL-TDOA), uplink angle of arrival (UL-AoA), etc.), and/or downlink-and-uplink-based (e.g., LTE/NR E-CID, multi-round trip time (multi-RTT), etc.).

The NG-RAN positioning procedures and UE positioning procedures may utilize LTE positioning protocol (LPP) signaling between the UE 204 and the LMF 270 and LPP type A (LPPa) or New Radio positioning protocol type A (NRPPa) signaling between the NG-RAN node 402 and the LMF 270. LPP is used point-to-point between a location server (e.g., LMF 270) and a UE (e.g., UE 204) in order to obtain location-related measurements or a location estimate or to transfer assistance data. A single LPP session is used to support a single location request (e.g., for a single mobile-terminated location request (MT-LR), mobile-originated location request (MO-LR), or network induced location request (NI-LR)). Multiple LPP sessions can be used between the same endpoints to support multiple different location requests. Each LPP session comprises one or more LPP transactions, with each LPP transaction performing a single operation (e.g., capability exchange, assistance data transfer, location information transfer). LPP transactions are referred to as LPP procedures.

A prerequisite for stage 430 is that an LCS Correlation identifier (ID) and an AMF ID has been passed to the LMF 270 by the serving AMF 264. Both, the LCS Correlation ID and the AMF ID may be represented as a string of characters selected by the AMF 264. The LCS Correlation ID and the AMF ID are provided by the AMF 264 to the LMF 270 in the location services request at stage 420. When the LMF 270 then instigates stage 430, the LMF 270 also includes the LCS Correlation ID for this location session, together with the AMF ID, which indicates the AMF instance serving the UE 204. The LCS Correlation ID is used to ensure that during a positioning session between the LMF 270 and the UE 204, positioning response messages from the UE 204 are returned by the AMF 264 to the correct LMF 270 and carrying an indication (the LCS Correlation ID) that can be recognized by the LMF 270.

Note that the LCS Correlation ID serves as a location session identifier that may be used to identify messages exchanged between the AMF 264 and the LMF 270 for a particular location session for a UE 204, as described in greater detail in 3GPP Technical Specification (TS) 23.273. As mentioned above and shown in stage 420, a location session between an AMF 264 and an LMF 270 for a particular UE 204 is instigated by the AMF 264, and the LCS Correlation ID may be used to identify this location session (e.g., may be used by the AMF 264 to identify state information for this location session, etc.).

LPP signaling can be used to request and report measurements related to the following positioning methods: LTE-OTDOA, DL-TDOA, assisted global navigation satellite system (A-GNSS), E-CID, sensor, terrestrial beacon system (TBS), WLAN, B:UETOOTH®, DL-AOD, UL-AoA, and multi-RTT. Currently, LPP measurement reports may contain the following measurements: (1) one or more time of arrival (ToA), TDOA, reference signal time difference (RSTD), or reception-to-transmission (Rx-Tx) time difference measurements, (2) one or more AoA and/or AoD measurements (currently only for a base station to report UL-AoA and DL-AoD to the LMF 270), (3) one or more multipath measurements (per-path ToA, RSRP, AoA/AoD), (4) one or more motion states (e.g., walking, driving, etc.) and trajectories (currently only for the UE 204), and (5) one or more report quality indications.

As part of the NG-RAN node positioning procedures (stage 430a) and UE positioning procedures (stage 430b), the LMF 270 may provide LPP assistance data in the form of downlink positioning reference signal (DL-PRS) configuration information to the NG-RAN node 402 and the UE 204 for the selected positioning method(s). Alternatively or additionally, the NG-RAN node 402 may provide DL-PRS and/or uplink PRS (UL-PRS) configuration information to the UE 204 for the selected positioning method(s). Note that while FIG. 4 illustrates a single NG-RAN node 402, there may be multiple NG-RAN nodes 402 involved in the positioning session.

Once configured with the DL-PRS and/or UL-PRS configurations, the NG-RAN node 402 and the UE 204 transmit and receive/measure the respective PRS at the scheduled times. The NG-RAN node 402 and the UE 204 then send their respective measurements to the LMF 270. In some cases, the NG-RAN node 402 may send its measurements to the UE 204, which may forward them to the LMF 270 using LPP signaling. Alternatively, the NG-RAN node 402 may send its measurements directly to the LMF 270 in LPPa or NRPPa signaling. In some cases, the UE 204 may send its measurements to the NG-RAN node 402 in RRC, uplink control information (UCI), or MAC control element (MAC-CE) signaling, and the NG-RAN node 402 may forward the measurements to the LMF 270 using LPPa or NRPPa signaling. Alternatively, the UE 204 may send its measurements directly to the LMF 270 using LPP signaling.

Once the LMF 270 obtains the measurements from the UE 204 and/or the NG-RAN node 402 (depending on the type(s) of positioning method(s)), it calculates an estimate of the UE's 204 location using those measurements. Then, at stage 440, the LMF 270 sends a location services response, which includes the location estimate for the UE 204, to the AMF 264. The AMF 264 then forwards the location services response to the entity that generated the location services request at stage 450. Specifically, if the location services request was received from a 5GC LCS entity 480 at stage 410a, then at stage 450a, the AMF 264 sends a location services response to the 5GC LCS entity 480. If, however, the location services request was received from the UE 204 at stage 410c, then at stage 450c, the AMF 264 sends a location services response to the UE 204. Or, if the AMF 264 generated the location services request at stage 410b, then at stage 450b, the AMF 264 stores/uses the location services response itself.

Note that although the foregoing has described the location services procedure 400 as a UE-assisted location services procedure, it may instead be a UE-based location services procedure. A UE-assisted location services procedure is one where the LMF 270 calculates the location of the UE 204, whereas a UE-based location services procedure is one where the UE 204 calculates its own location. In the case of a UE-based location services procedure, stages 410c and 450c would be performed. The LMF 270 may still coordinate the transmission/measurement of DL-PRS (and possibly UL-PRS), but the measurements would be forwarded to the UE 204 rather than the LMF 270. As such, the location services response at stages 440 and 450c may be the measurements from the involved NG-RAN node(s) 402 rather than a location estimate of the UE 204.

Alternatively, where the involved NG-RAN node(s) 402 forward their respective measurements directly to the UE 204 (e.g., via RRC signaling), the location services response at stage 440 may simply be a confirmation that the NG-RAN node and UE positioning procedures at stage 430 are complete.

In the cell identifier (CID) positioning method, a UE's location is estimated based on the knowledge of the geographical coordinates of its serving ng-eNB (e.g., ng-eNB 224) or gNB (e.g., gNB 222). Enhanced cell ID (E-CID) positioning based on LTE signals refers to techniques that use UE and/or NG-RAN radio resource-related measurements to improve the UE's location estimate. For E-CID positioning, the UE reports only the measurements that it has available, rather than being required to take additional measurement actions.

Depending on which entity is providing the measurements (the UE or the NG-RAN node), there are two types of E-CID positioning methods: uplink and downlink. Uplink E-CID positioning procedures take place between the NG-RAN node (an ng-eNB or a gNB) and the LMF (e.g., via New Radio positioning protocol type A (NRPPa)). Specifically, these types of procedures support E-CID related measurements obtained by the NG-RAN node and provided to the LMF using NRPPa. The term “uplink” is intended to indicate that from the LMF point of view, the involved measurements are provided by the NG-RAN node; this set of procedures might also be considered as “NGRAN node-assisted E-CID.” An example of uplink E-CID positioning method for Enhanced Universal Terrestrial Radio Access (E-UTRA) is angle of arrival (AoA) plus timing advance. Note that in the case of a serving ng-eNB, uplink E-CID may use inter-RAT NR, GSM Enhanced Data rates for GSM Evolution (EDGE) radio access network (GERAN), Universal Terrestrial Radio Access (UTRA), or WLAN measurements reported by the UE.

Downlink E-CID positioning procedures take place between the UE and the LMF (e.g., via LTE positioning protocol (LPP)). Specifically, these types of procedures support E-CID related measurements obtained by the UE and provided to the LMF using LPP. The term “downlink” is intended to indicate that from the LMF perspective the involved measurements are provided by the UE; this set of procedures might also be considered as “UE-assisted, LMF-based E-CID.”

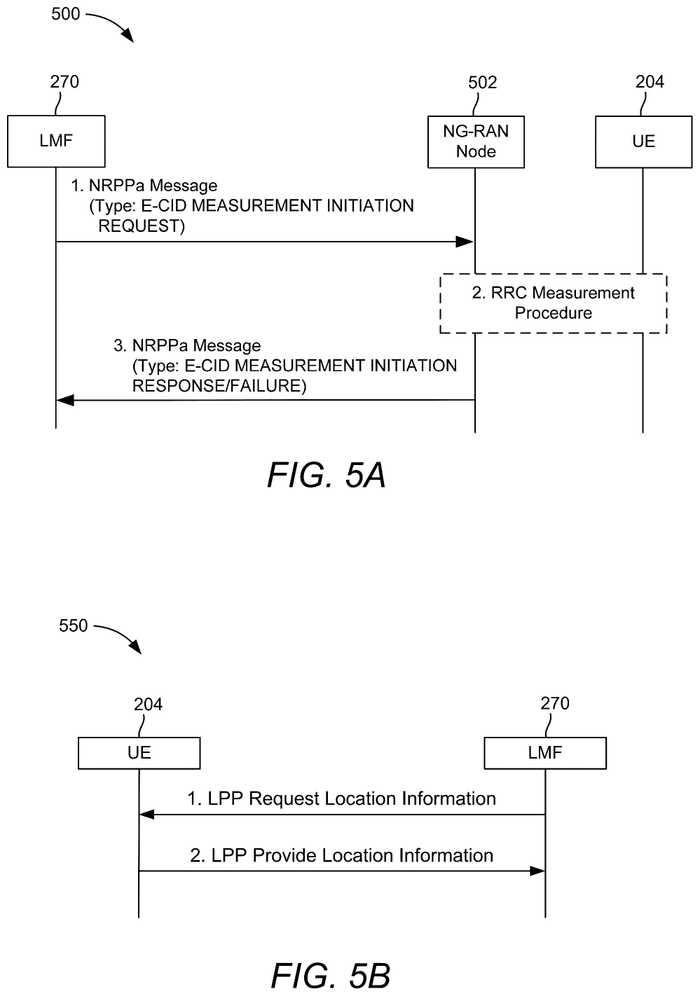

FIG. 5A illustrates an example uplink E-CID measurement procedure 500 between an NG-RAN node 502 (e.g., a gNB 222 or an ng-eNB 224) and an LMF 270, according to aspects of the disclosure. The purpose of the uplink E-CID measurement procedure 500 is to allow the LMF 270 to request the NG-RAN node 502 to report E-CID measurements used by the LMF 270 to compute the location of a UE 204. Accordingly, at stage 1, the LMF 270 sends an NRPPa E-CID MEASUREMENT INITIATION REQUEST message to the NG-RAN node 502. This request includes an indication of the E-CID measurements requested and whether the result is expected only once or periodically.

If the LMF 270 in stage 1 requested UE measurements (e.g., E-UTRA RSRP, E-UTRA RSRQ, etc.), the NG-RAN node 502 may configure the UE 204 to report the measurement information requested. Thus, at stage 2, the UE 204 and the NG-RAN node 502 may optionally perform an RRC measurement procedure.

If the result is expected only once and the NG-RAN node 502 initiates at least one of the E-CID measurements as requested, then at stage 3, the NG-RAN node 502 sends an NRPPa E-CID MEASUREMENT INITIATION RESPONSE to the LMF 270, which includes the obtained E-CID measurements. If the result is expected periodically and the NG-RAN node 502 is able to initiate at least one of the E-CID measurements as requested, then at stage 3, the NG-RAN node 502 sends an NRPPa E-CID MEASUREMENT INITIATION RESPONSE to the LMF 270 that does not include any result. The NG-RAN node 502 reports the obtained measurements by initiating the E-CID Measurement Report procedure with the requested periodicity. If the NG-RAN node 502 is unable to initiate any of the requested measurements as requested from the LMF 270 or is unable to instigate any of the required RRC procedures to obtain the requested measurements from the UE 204, then at stage 3, the NG-RAN node 502 sends an NRPPa E-CID MEASUREMENT INITIATION FAILURE message providing the error reason. If the failure occurs during a periodic reporting, the NG-RAN node 502 sends an NRPPa E-CID MEASUREMENT FAILURE INDICATION message (not shown).

The following table shows the information that may be transferred from the NG-RAN node 502 to the LMF 270.

TABLE 1
Information

Timing Advance (T_{ADV})
Angle of Arrival (AoA)
E-UTRA Measurement Results List:
Evolved Cell Global Identifier (ECGI)/Physical Cell ID
E-UTRA Reference signal received power (RSRP)
E-UTRA Reference Signal Received Quality (RSRQ)
GERAN Measurement Results List:
Base Station Identity Code (BSIC)
Absolute Radio Frequency Channel Number (ARFCN) of Base Station
Control Channel (BCCH)
Received Signal Strength Indicator (RSSI)
UTRA Measurement Results List:
UTRAN Physical ID
Common Pilot Channel Received Signal Code Power (RSCP)
Common Pilot Channel Ec/Io
WLAN Measurement Results List:
WLAN Received Signal Strength Indicator (RSSI)
Service Set Identifier (SSID)
Basic Service Set Identifier (BSSID)
Homogenous Extended Service Set Identifier (HESSID)
Operating Class
Country Code
WLAN Channel(s)
WLAN Band
NR Measurement Results List:
SS Reference Signal Received Power (SS-RSRP)
SS Reference Signal Received Quality (SS-RSRQ)
NR Physical Cell ID

FIG. 5B illustrates an example Location Information Transfer operation 550 for an E-CID method, according to aspects of the disclosure. The Location Information Transfer operation 550 may be an LPP location information transfer procedure for an E-CID positioning procedure.

At stage 1, the LMF 270 initiates the Location Information Transfer operation 550 by sending an LPP Request Location Information message to the UE 204 for invocation of E-CID positioning. This request includes the E-CID measurements requested by the LMF 270 and supported by the UE 204 as listed in Table 2 below, together with a required response time.

At stage 2, the UE 204 sends an LPP Provide Location Information message to the LMF 270 and reports the requested measurements that are available in the UE 204 before the response time provided in stage 1 elapses. If the requested measurements are not available, or if the response time provided in stage 1 elapses before any of the requested measurements have been obtained, the UE 204 returns any information that can be provided in an LPP message of type Provide Location Information that includes a cause indication for the not provided location information.

The following table shows the information that may be transferred from the UE 204 to the LMF 270. Using downlink E-CID in LPP, as illustrated in FIG. 5B, a UE can report measurements for up to 32 neighbor cells.

TABLE 2

| Information | UE-assisted |
|---|---|
| Evolved Cell Global Identifier (ECGI)/Physical Cell ID | Yes |
| E-UTRA Reference signal received power (RSRP) | Yes |
| E-UTRA Reference Signal Received Quality (RSRQ) | Yes |
| UE E-UTRA Rx − Tx time difference | Yes |

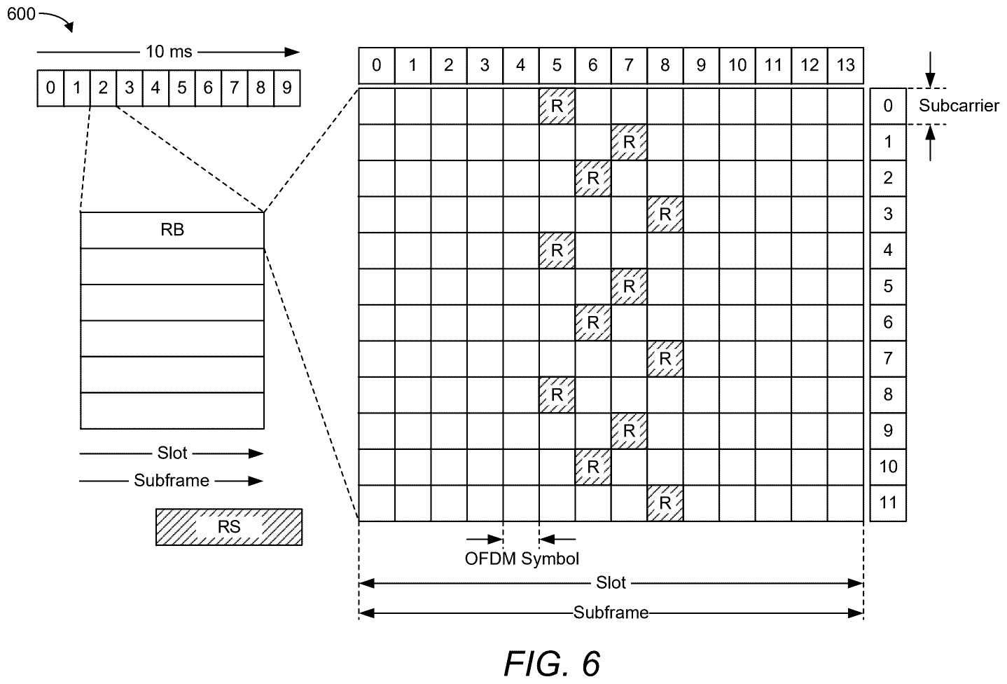

Various frame structures may be used to support downlink and uplink transmissions between network nodes (e.g., base stations and UEs). FIG. 6 is a diagram 600 illustrating an example frame structure, according to aspects of the disclosure. The frame structure may be a downlink or uplink frame structure. Other wireless communications technologies may have different frame structures and/or different channels.

LTE, and in some cases NR, utilizes orthogonal frequency-division multiplexing (OFDM) on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal fast Fourier transform (FFT) size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (μ), for example, subcarrier spacings of 15 kHz (μ=0), 30 kHz (μ=1), 60 kHz (μ=2), 120 kHz (μ=3), and 240 kHz (μ=4) or greater may be available. In each subcarrier spacing, there are 14 symbols per slot. For 15 kHz SCS (μ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 6, a numerology of 15 kHz is used. Thus, in the time domain, a 10 ms frame is divided into 10 equally sized subframes of 1 ms each, and each subframe includes one time slot. In FIG. 6, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 6, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 6 illustrates example locations of REs carrying a reference signal (labeled “R”).

An over-the-top (OTT) server (a third-party server external to an operator's cellular network) may perform positioning operations with one or more UEs, much like a location server (e.g., LMF 270), but without coordinating with a location server or any base stations to configure specific reference signal transmissions for the UE(s) to measure. Rather, the OTT server and UE(s) utilize reference signals already transmitted in cellular networks (e.g., 5G and/or LTE networks). This type of positioning, without coordination with a location server or base station, but rather, utilizing reference signals that are already scheduled to be transmitted to and measured by a connected UE, is referred to as “OTT-based positioning,” “OTT positioning,” and the like. The reference signals measured by the UE are referred to as “OTT reference signals,” “OTT signals,” and the like.

For example, TRS may be used for positioning purposes, such as OTT-based positioning. TRS are configured in each cell with their own time, frequency, and scrambling identifier. It is mandatory for all UEs to support TRS reception, and all 5G networks are required to transmit TRS. However, a UE is only aware of the TRS configuration of its serving cell. In addition, the TRS in one cell may collide with data, TRS, or CSI-RS in neighboring cells.

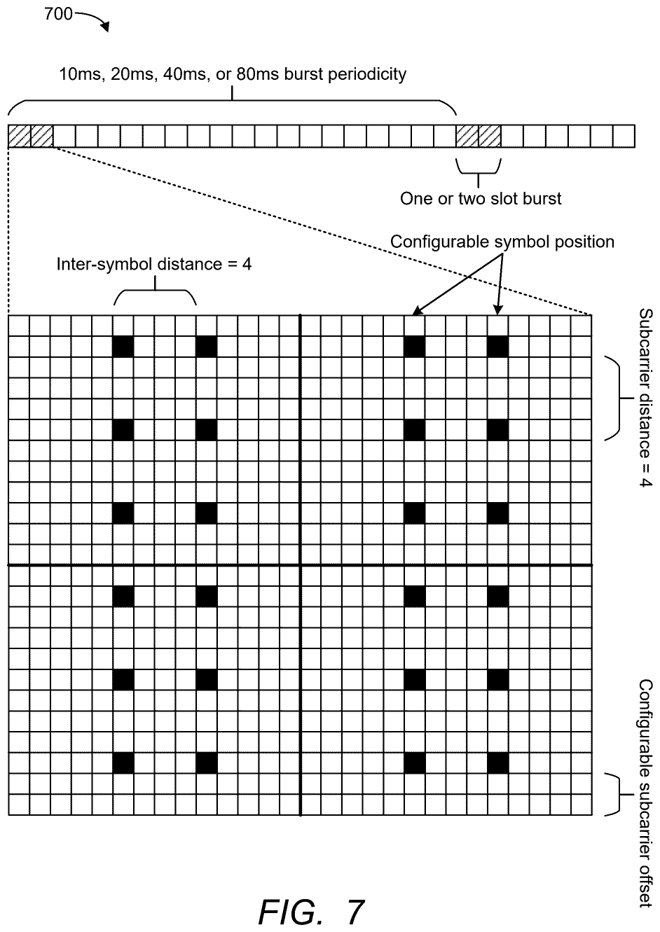

FIG. 7 is a diagram 700 illustrating an example TRS configuration, according to aspects of the disclosure. In FIG. 7, time is represented horizontally (on the X axis) with time increasing from left to right, while frequency is represented vertically (on the Y axis) with frequency increasing (or decreasing) from bottom to top. In the example of FIG. 7, two sequential slots are expanded to show the resource elements of four resource blocks making up the two slots.

As shown in FIG. 7, TRS are transmitted in a burst of one or two slots with a periodicity of 10 ms, 20 ms, 40 ms, or 80 ms. Within a slot, the positions of the symbols carrying the TRS are configurable, provided there is a four-symbol inter-symbol distance between the TRS symbols. For FR1, the permitted symbol pair positions are (4, 8), (5, 9), and (6, 10). For FR2, all symbol pair positions within one slot are allowed. In the frequency domain, there is a fixed subcarrier distance between TRS subcarriers of four subcarriers. There is also a configurable subcarrier offset within each resource block. The TRS bandwidth may be equal to the device's downlink bandwidth part (DL-BWP) (i.e., as large as 272 PRBs) or 48 PRBs.

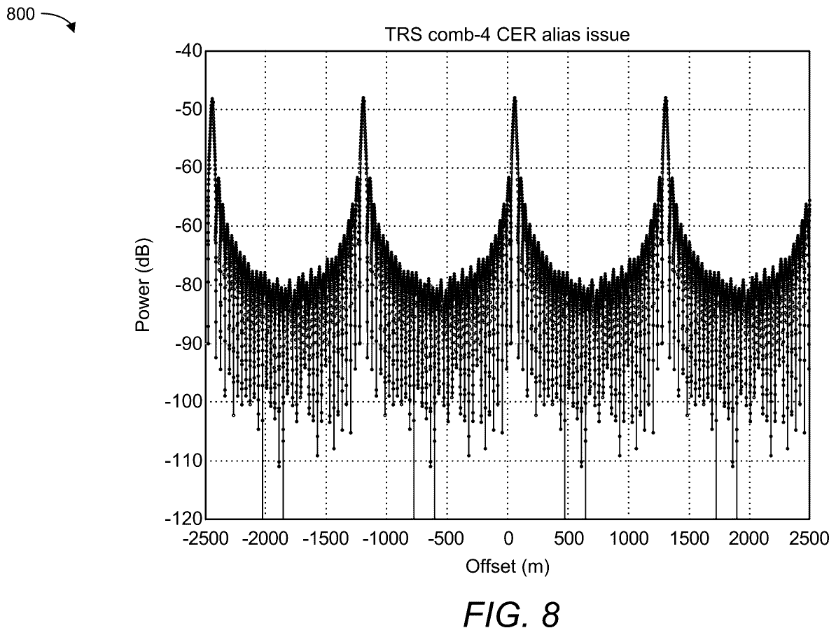

As shown in FIG. 7, TRS are not fully staggered in the frequency domain (TRS are transmitted with a comb-4 comb pattern), and therefore, four peaks are expected to be observed in the channel estimate (e.g., channel energy response (CER)) of the TRS. More specifically, because TRS are transmitted on a given symbol with gaps in the frequency domain, it results in aliasing of the channel estimate. Aliasing is a result of converting the frequency domain to the time domain when estimating the channel estimate, and appears as multiple equally sized peaks, as shown in FIG. 8. Specifically, FIG. 8 is a graph 800 of a CER estimate for a single symbol where the measured TRS is transmitted using a comb-4 pattern. As shown in FIG. 8, the CER has four significant peaks, due to the TRS being transmitted with a comb-4 pattern (i.e., on every fourth subcarrier), but only one of these peaks is the “true” peak (i.e., represents the actual time of arrival (ToA) of the TRS in that symbol). However, because the TRS in a cell is quasi-co-located with the SSB in the cell, the SSB can also be measured to solve the time-domain aliasing problem of the TRS in that cell.

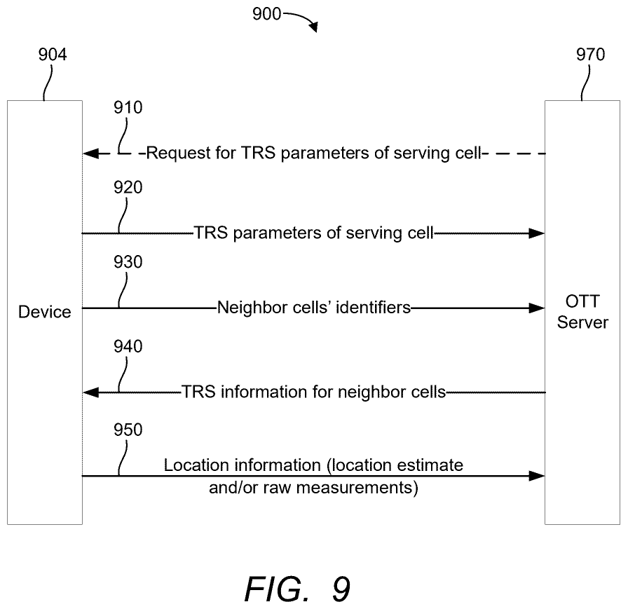

FIG. 9 illustrates an example OTT-based positioning procedure 900 using TRS, according to aspects of the disclosure. The OTT-based positioning procedure 900 may be performed between a client device 904 (e.g., a mobile device, an IoT device, or any other type of UE) and an OTT server 970 (e.g., a third-party server, a connected intelligent edge (CIE) server, etc.).

At stage 910, the OTT server 970 optionally sends a request to a client device 904 to report TRS configuration parameters (e.g., symbol pattern, symbol offset, frequency offset, number of slots per burst, burst periodicity, scrambling identifier, QCL relation, PCI, etc.) for the device's 904 serving cell. The request may configure the device 904 to report the TRS configuration parameter periodically or when any change is determined. The request may also configure the device 904 to report only the TRS configuration for a subset of TRS detected by the device 904 based on certain criteria. For example, the request may configure the device 904 to only report the TRS configuration(s) for TRS having a signal strength above a threshold. The request may also configure the device 904 to only report TRS configurations associated to a specific component carrier, frequency band, or frequency range (e.g., FR1 and/or FR2). Further, the request may configure the device 904 to transition to an RRC connected state for the purpose of gathering the TRS configuration parameters from the network.

At stage 920, the device 904 reports the requested TRS configuration parameters to the OTT server 970. Note that the device 904 may automatically report the TRS parameters of its serving cell without receiving a request from the OTT server 970 at stage 910, such as when changing serving cells or on a periodic basis.

At stage 930, the device 904 reports the identifiers (e.g., PCIs) of any neighbor cells that it discovered through, for example, radio resource management (RRM) procedures. The device 904 may also send RSRP, RSRQ, SINR, and/or received signal strength indication (RSSI) measurements associated with the PCIs of the neighbor cells. The report may include component carrier(s), frequency band(s), frequency range(s), slot offset(s), periodicity(ies), subframe-offset(s), time window(s), and/or preferred TRS configurations to be provided by the OTT server 970 (if available). These parameters can be reported in priority order.

Note that stages 920 and 930 may be a single transmission sequence or multiple transmission sequences. For example, the device 904 may transmit, and the OTT server 970 receive, both the serving cell information (e.g., the requested TRS configuration parameters) and the neighbor cell information (e.g., the identifiers of any neighbor cells) in the same data transmission (i.e., stages 920 and 930 are a single transmission sequence), or the device 904 may first transmit, and the OTT server 970 may first receive, the serving cell information and then the neighbor cell information (i.e., stages 920 and 930 are separate transmissions).

At stage 940, based on the identifiers of the neighbor cells, the OTT server 970 provides the TRS configuration for the identified neighbor cells to the device 904. The response may include one or more TRS configurations associated with a specific PCI and/or associated with SSBs from that PCI. The multiple TRS configurations may be “alternatives” for the device 904 to attempt to detect. The response may also include timestamps, validity timers, expiration timers, or the like indicating when the provided configurations are valid.

In an aspect, the OTT server 970 may have obtained the TRS information for the neighbor cells based on performing stages 910 and 920 with multiple other devices, thereby creating a crowdsourced database of the TRS parameters of multiple cells. In some cases, where the OTT server 970 does not have the TRS information for a neighbor cell indicated at stage 940, it can send a request, as at stage 910, to another device 904 that is known to have that neighbor cell as its serving cell. The OTT server 970 can thereby obtain the TRS configuration parameters for that cell from the other device 904, as at stage 920.

At stage 950, the device 904 reports location information to the OTT server 970. For UE-based positioning, the location information may be the device's 904 estimated location as determined from measurements (e.g., time of arrival (ToA), time difference of arrival (TDoA), reference signal time difference (RSTD)) of the TRS transmitted by the serving cell and the neighbor cells for which it received the TRS configuration information. Alternatively, or additionally, the location information may be the raw measurements of the TRS and the timestamps at which those measurements were obtained (as for UE-assisted positioning). The device 904 may also report which TRS were successfully detected, or which were not detected. That is, the device 904 may report the identifiers of the neighbor cells in which it detected or failed to detect the indicated TRS.

As will be appreciated, while the foregoing has described using TRS for positioning, the OTT-based positioning procedure 900 may instead be performed using CSI-RS or any other downlink reference signal specific to a serving cell. The OTT-based positioning procedure 900 may also be implemented in Wi-Fi networks, using, for example, LTS signals.

When using OTT signals (such as TRS, LTS, etc.), the UE or location server combines the ToA and/or TDoA measurements with its knowledge of the anchor nodes' locations to determine a reliable position estimate for the UE. It is assumed that the UE or location server has access to a (1) a list of ToA and/or TDoA estimates and (2) a list of probable anchor locations. The list of ToA and/or TDoA estimates is derived by the UE based on its measurements for UE-based position estimation or reported to the location server for network-based position estimation. The list of probable anchor locations is provided by the location server to the UE (for UE-based positioning) and contains the locations of anchor nodes in the surrounding region of the UE. The UE or location server combines the information in the two lists using reverse positioning to determine a mapping from the ToA and/or TDoA measurements to the respective anchor node locations. This can then be used for positioning.

The list of probable anchor locations, along with other available information about anchor nodes relevant for positioning, is included in a base station almanac (BSA). The location server may provide to a UE all information in the BSA for the anchor nodes in the region of the UE or only the information relevant to the specific type of positioning or the specific measurements/calculations performed by the UE.

A positioning procedure (whether RAT-dependent or OTT) may not always succeed due, for example, to incomplete BSA information. For example, referring to the E-CID positioning method, there could be multiple reason for the positioning calculation to fail, such as (1) the serving cell is not found the in the BSA, (2) the serving cell ARFCN is not available in the BSA, (3) the serving cell mobile country code (MCC) and/or mobile network code (MNC) is not available in the BSA, (4) the BSA is not prepared for the given region (meaning more time is needed to complete BSA generation, or (5) the BSA is being prepared for a given region (meaning comparatively less time is needed to complete BSA generation).

As another example, the identifiers of anchor nodes (e.g., the cell IDs of TRPs in 5G and/or the SSIDs of APs in Wi-Fi) may be scrambled from time to time (e.g., once a day), which can make it impossible to compute a UE's position without knowledge of which anchor position corresponds to which measurement.

Without knowledge of the reason for the failure of the positioning session, a UE may immediately request performance of a subsequent positioning session. Depending on the reason for the failure, this can waste system resources, as it may result in yet another failure. Accordingly, the present disclosure provides techniques to prevent the UE from transmitting positioning requests to the location server again and again.

As a first technique described herein, there may be a “backoff” period before a UE is permitted to make a subsequent positioning request. In this case, signaling between the UE and the location server may indicate how long a UE is restricted from making a new positioning request after a failed positioning request. As a first option, the backoff period may be serving cell based, where the UE is only permitted to make a new positioning request after changing its severing cell. As a second option, the backoff period may be ARFCN and/or frequency cell based, where the UE is only permitted to make a new positioning request after changing ARFCN and/or frequency. As a third option, the backoff period may be MCC/MNC based, where the UE is only permitted to make a new positioning request after changing MCC/MNC (i.e., a network operator change). As a fourth option, the backoff period may be timer based, where UE is only permitted to make a new positioning request after expiration of a location server provided timer.

In some cases, there may be a common or dedicated backoff rule. For a common rule, the location server may provide one common backoff rule for standard positioning methods and another backoff rule for premier positioning methods. Alternatively, the location server may provide a common backoff rule for all positioning methods (e.g., E-CID, TRS-based, SSB-based, CRS-based, GTP-based, Wi-Fi-based, etc.).

Similarly, for a dedicated rule, the location server may provide one dedicated backoff rule for standard positioning methods and another backoff rule for premier positioning methods. Alternatively, the location server may provide a dedicated backoff rule for all positioning methods (e.g., E-CID, TRS-based, SSB-based, CRS-based, GTP-based, Wi-Fi-based, etc.). For example, there may be a dedicated rule indicating that after a positioning failure, the UE may request an E-CID positioning procedure but may not request a TRS-based positioning procedure. As another example, there may be a dedicated rule indicating that after a positioning failure, standard positioning is allowed but premier-based positioning is not allowed.

The timer-based techniques described above are UE-specific in nature, meaning that all the UE need to connect to the location server to receive the updated barring information from the location server. This is not efficient and requires a significant amount of signaling within the overall system.

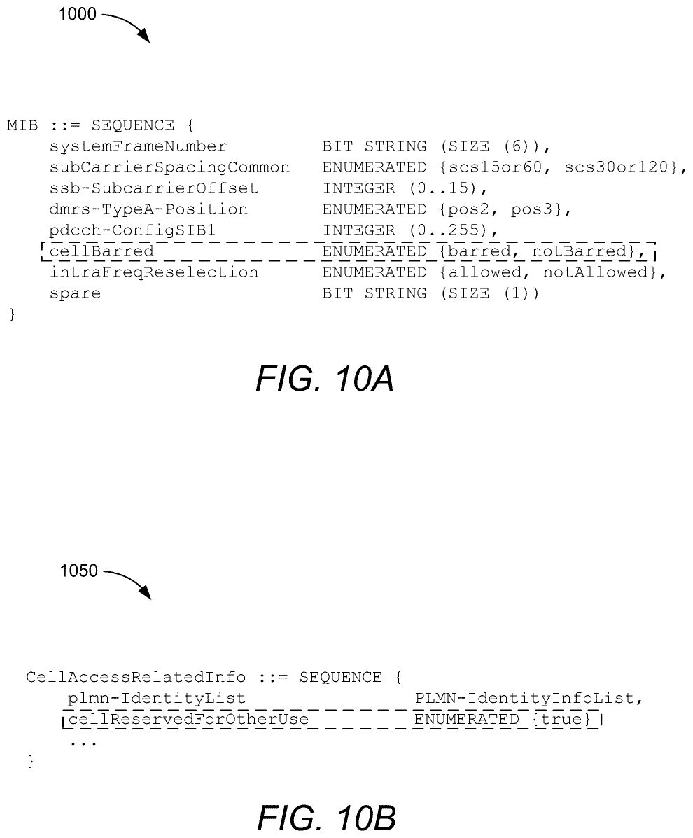

Currently, cell reservations and access restrictions for radio resource management (RRM) are based on a set of flags included within the MIB and SIB. This set of flags indicates permissions for cell selection and cell reselection. In 5G NR, an MIB includes cell barring information with a “cellBarred” information element (IE), which can be broadcast with a value of ‘barred’ or ‘notBarred.’ This flag allows early detection of the status without requiring the UE to receive and decode SIB-1. If a cell is barred, then the UE is not permitted to select or reselect the cell. FIG. 10A illustrates an example MIB 1000 containing the “cellBarred” IE, according to aspects of the disclosure.

Current cell barring may be based on frequency or a MIB/SIB decoding failure. Referring to the former, if the MIB indicates that a cell is barred, then the UE also checks the “intraFreqReselection” flag, which is also included within the MIB. If this flag is set to ‘notAllowed,’ then the UE is not permitted to reselect another cell on the same frequency. Otherwise, if this flag is set to ‘Allowed,’ then the UE is permitted to reselect another cell on the same frequency.

Referring to cell barring based on MIB/SIB decoding failures, a UE also treats a cell as barred if the UE fails to decode the MIB. In this case, the UE is allowed to reselect another cell on the same frequency. Additionally, if the UE fails to decode SIB-1, then the UE treats a cell as barred. In this case, the UE uses the “intraFreqReselection” flag from within the MIB to determine whether or not reselection to another cell on the same frequency is allowed. The UE treats the cell as barred for up to 300 seconds when it fails to decode the MIB or SIB-1.

A 5G NR SIB-1 includes a “cellReservedForOperatorUse” flag that can be broadcast with a value of ‘reserved’ or ‘not Reserved.’ If a cell is reserved, then a UE with an Access Identity of 11 (indicating that it is for public land mobile network (PLMN) use) or an Access Identity of 15 (indicating that it is for PLMN staff) is allowed to use the cell for selection and reselection, if that UE is within its Home PLMN or an Equivalent Home PLMN. If a cell is reserved, then a UE with Access Identity 0, 1, 2, 12, 13, or 14 treats the cell as ‘barred’ and not allowed for selection or reselection.

Another flag in SIB-1, the “cellReservedForOtherUse” flag, can be broadcast with a value of ‘true’ or can be excluded. When this flag is broadcast by SIB-1, then all UE treat the cell as ‘barred.’ That is, it has the same impact as the “cellBarred” flag within the MIB. There is a single instance of the flag that is applicable to all PLMN. FIG. 10B illustrates a portion of an example SIB-1 1050 that includes a “cellReservedForOtherUse” flag, according to aspects of the disclosure.

The “cellReservedForOtherUse” flag does not have a specific purpose within the Release 15 version of the 3GPP specifications, but has been introduced to provide forward compatibility with services that may be introduced in the future. For example, closed subscriber group (CSG) cells can be used to show how this flag provides forward compatibility. If future versions of the specifications support CSG cells, then those UEs will understand the rules for accessing a CSG cell (which are that only subscribers belonging to the CSG are permitted to access the cell). Release 15 UEs will not have any knowledge of these rules, but the “cellReservedForOtherUse” flag can be used to ensure that a Release 15 UE does not attempt to access the CSG cell.

As a second technique for providing a backoff period, all positioning cell barring information may be provided through cell broadcast messages. In this case, rather than a timer-based backoff period where the UE needs to connect to the location server to receive the updated barring information, the location server can request a base station (e.g., a gNB) to broadcast the positioning barring signaling. The signaling may include the specific cause(s) described above (e.g., serving cell based backoff period, ARFCN and/or frequency cell based backoff period, MCC/MNC based backoff period, timer based backoff period).

As a first option, a base station may broadcast a dedicated SIB for positioning barring information. This may be, for example, another type of positioning SIB (pos-SIB). As a second option, the existing cell baring information in the MIB and SIB may be extended to include positioning related information.

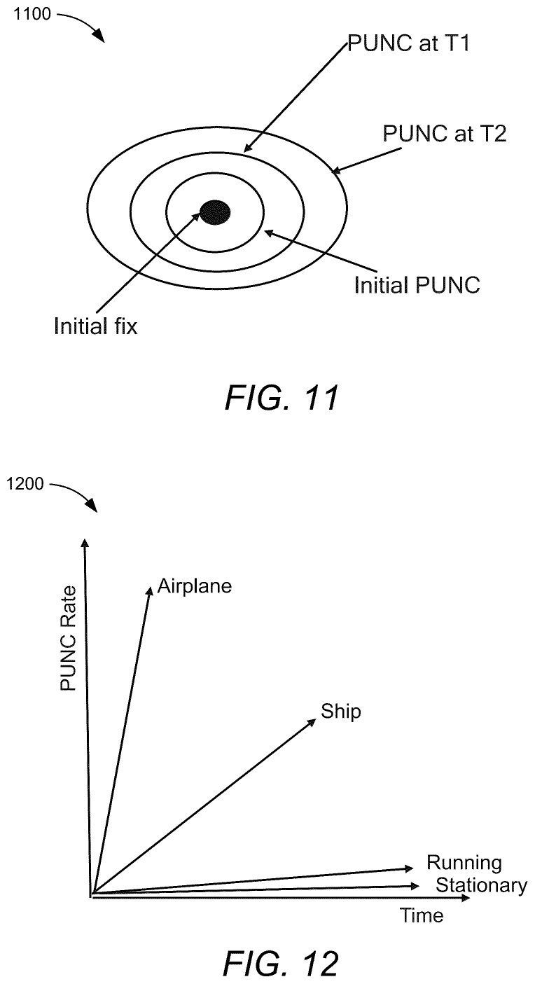

As a third technique for providing a backoff period, the backoff time may be based on a positioning uncertainty (PUNC) propagation model. This technique may be used as a power saving feature. In this case, the location server may provide a valid position fix for the UE and an initial positioning uncertainty (i.e., an uncertainty of the positioning fix). The location server may indicate that the position fix is valid for a duration of time T. The positioning uncertainty grows as a function of time, or more specifically, as a function of the positioning uncertainty propagation model over time. However, the UE may request a new positioning fix only (1) after the duration T and (2) the positioning uncertainty grows greater than a threshold value. The positioning uncertainty threshold may be configured to the UE by the location server. FIG. 11 is a diagram 1100 illustrating an example of positioning uncertainty (PUNC) increasing with time, according to aspects of the disclosure.

There may be different types of positioning uncertainty propagation models. As a first option, the positioning uncertainty propagation model may be a linear model, such as: PUNC_new=PUNC_old+R*T, where R is the rate of change. As a second option, the positioning uncertainty propagation model may be a quadric model, such as: PUNC_new=PUNC_old+A*T\hat{ }2+B*T+C, where A and B are the rate of change and C is a constant. As a third option, the positioning uncertainty propagation model may be any linear and non-linear function, such as: PUNC_new=PUNC_old+F(T), where F (T) is a function based on time and provided by the location server.

With continued reference to the positioning uncertainty propagation model, many UEs have sensors that can detect whether the UE is stationary or in motion. These sensors may include a speedometer, one or more accelerometers, a pedometer, etc. and may be used to classify a UE's motion as stationary, walking, running, ship (10 to 50 kilometers per hour (Kph)), vehicle (50 to 100 Kph), vehicle (100 to 200 Kph), airplane, etc. FIG. 12 is a diagram 1200 illustrating relative positioning uncertainty propagation rates of different types of UE motion classifications, according to aspects of the disclosure.

Based on the motion classification, a UE may use different positioning uncertainty propagation models for propagating positioning uncertainty. For example, a stationary UE may use a very low positioning uncertainty propagation rate compared to an in-motion UE. In some cases, different positioning uncertainty propagation rates for different motion states can be up to UE implementation or configured to the UE by the location server.

There may be different UE implementations after receiving the positioning barring information. As a first case, where the serving cell is barred for the UE making any further positioning requests to the location server before expiration of the backoff period, the UE may try to reselect to another suitable cell and try to perform another positioning session. In this case, the signal strength of the other suitable cell should be within X decibels (dB) for the signal strength of the UE's current serving cell. This technique may be restricted to specific use cases.

As a second case, where an ARFCN/frequency is barred for the UE making any further positioning requests to the location server before expiration of the backoff period, the UE may try to reselect to another suitable frequency and try to perform another positioning session. In this case, the signal strength of the cell on the other frequency should be within Y dB of the signal strength of the current serving cell. This technique may also be restricted to specific use cases.

As a third case, where the MCC and/or MNC is barred for the UE making any further positioning requests to the location server before expiration of the backoff period, the UE may try to reselect to another subscription, if available, to make another positioning request. For example, the UE may be equipped with a first subscriber identity module (SIM), denoted “SIM1,” for a first network operator (e.g., VERIZON®) and a second SIM, denoted “SIM2,” for a second network operator (e.g., T-MOBILE®). In this example, the MCC/MNC for the first network operator may be barred for further positioning sessions before expiration of the backoff period. Thus, the UE may perform a PLMN search to determine whether any other MMC/MNC is available to make the positioning session request. If the second SIM (SIM2) is available for positioning requests, the UE will opportunistically select SIM2 for the positioning session.

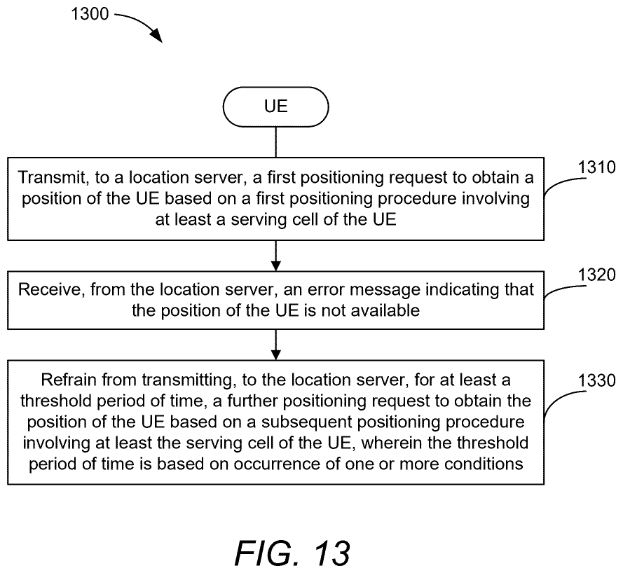

FIG. 13 illustrates an example method 1300 of wireless communication, according to aspects of the disclosure. In an aspect, method 1300 may be performed by a UE (e.g., any of the UEs described herein).

At operation 1310, the UE may transmit, to a location server, a first positioning request to obtain a position of the UE based on a first positioning procedure involving at least a serving cell of the UE. In an aspect, operation 1310 may be performed by the one or more WWAN transceivers 310, the one or more short-range wireless transceivers 320, the one or more processors 342, memory 340, and/or positioning component 348, any or all of which may be considered means for performing this operation.

At operation 1320, the UE may receive, from the location server, an error message indicating that the position of the UE is not available. In an aspect, operation 1320 may be performed by the one or more WWAN transceivers 310, the one or more short-range wireless transceivers 320, the one or more processors 342, memory 340, and/or positioning component 348, any or all of which may be considered means for performing this operation.

At operation 1330, the UE may refrain from transmitting, to the location server, for at least a threshold period of time, a further positioning request to obtain the position of the UE based on a subsequent positioning procedure involving at least the serving cell of the UE, where the threshold period of time is based on occurrence of one or more conditions. In an aspect, operation 1330 may be performed by the one or more WWAN transceivers 310, the one or more short-range wireless transceivers 320, the one or more processors 342, memory 340, and/or positioning component 348, any or all of which may be considered means for performing this operation.

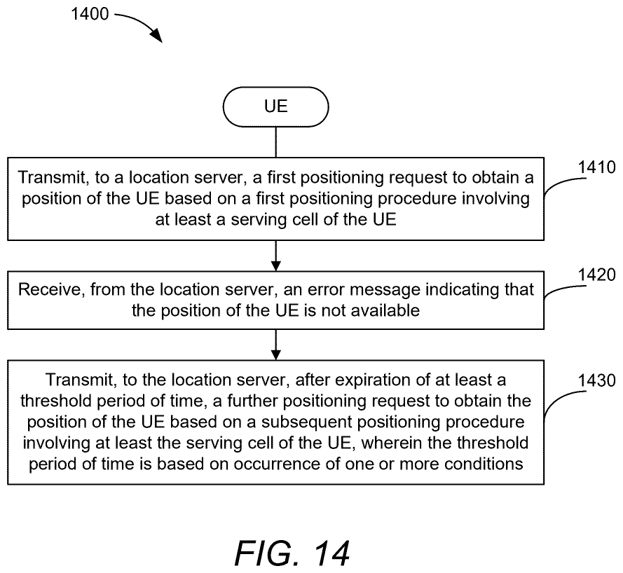

FIG. 14 illustrates an example method 1400 of wireless communication, according to aspects of the disclosure. In an aspect, method 1400 may be performed by a UE (e.g., any of the UEs described herein).

At operation 1410, the UE may transmit, to a location server, a first positioning request to obtain a position of the UE based on a first positioning procedure involving at least a serving cell of the UE. In an aspect, operation 1410 may be performed by the one or more WWAN transceivers 310, the one or more short-range wireless transceivers 320, the one or more processors 342, memory 340, and/or positioning component 348, any or all of which may be considered means for performing this operation.

At operation 1420, the UE may receive, from the location server, an error message indicating that the position of the UE is not available. In an aspect, operation 1420 may be performed by the one or more WWAN transceivers 310, the one or more short-range wireless transceivers 320, the one or more processors 342, memory 340, and/or positioning component 348, any or all of which may be considered means for performing this operation.

At operation 1430, the UE may transmit, to the location server, after expiration of at least a threshold period of time (and not before expiration of the threshold period of time), a further positioning request to obtain the position of the UE based on a subsequent positioning procedure involving at least the serving cell of the UE, where the threshold period of time is based on occurrence of one or more conditions. In an aspect, operation 1430 may be performed by the one or more WWAN transceivers 310, the one or more short-range wireless transceivers 320, the one or more processors 342, memory 340, and/or positioning component 348, any or all of which may be considered means for performing this operation.

As will be appreciated, a technical advantage of the methods 1300 and 1400 is preventing the UE from repeatedly transmitting positioning requests to the location server, thereby reducing unnecessary signaling overhead.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:
Clause 1. A method of wireless communication performed by a user equipment (UE), comprising: transmitting, to a location server, a first positioning request to obtain a position of the UE based on a first positioning procedure involving at least a serving cell of the UE; receiving, from the location server, an error message indicating that the position of the UE is not available; and transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.
Clause 2. The method of clause 1, wherein the error message includes one or more error reasons indicating: the serving cell of the UE was not found in a base station almanac (BSA) available to the location server, an operating frequency channel of the serving cell of the UE is not available in the BSA, an operating frequency of the serving cell of the UE is not available in the BSA, a network operator of the serving cell of the UE is not available in the BSA, no BSA is available for a region including the serving cell of the UE, or any combination thereof.
Clause 3. The method of any of clauses 1 to 2, wherein the one or more conditions comprise: a change in serving cell of the UE, a change in an operating frequency channel of the UE, a change in an operating frequency of the UE, a change in network operator of the UE, an expiration of a timer, or any combination thereof.
Clause 4. The method of any of clauses 1 to 3, further comprising: receiving, from the location server, one or more backoff rules for refraining from transmitting further positioning requests for at least the threshold period of time, wherein the one or more backoff rules indicate the one or more conditions.
Clause 5. The method of clause 4, wherein: the one or more backoff rules are specific to different types of positioning methods, or the one or more backoff rules are common to different types of positioning methods.
Clause 6. The method of any of clauses 1 to 5, further comprising: receiving a broadcast of one or more system information blocks, wherein the one or more system information blocks include positioning barring information.
Clause 7. The method of clause 6, wherein the positioning barring information includes the one or more conditions.
Clause 8. The method of any of clauses 1 to 7, wherein the one or more conditions comprise: an expiration of a timer indicating that a previous position fix of the UE is valid, a positioning uncertainty of the previous position fix of the UE being greater than a threshold, or any combination thereof.
Clause 9. The method of clause 8, wherein the positioning uncertainty of the previous position fix of the UE is based on a positioning uncertainty propagation model.
Clause 10. The method of clause 9, wherein the positioning uncertainty propagation model is: a linear model, a quadratic model, a linear function, or a non-linear function.
Clause 11. The method of any of clauses 9 to 10, wherein the positioning uncertainty propagation model is based on a motion classification of the UE.
Clause 12. The method of any of clauses 1 to 11, further comprising: transmitting, to the location server, before expiration of the threshold period of time, a second positioning request to obtain the position of the UE based on a positioning procedure involving at least a different cell than the serving cell of the UE.
Clause 13. The method of clause 12, wherein the different cell operates at a different operating frequency than an operating frequency of the serving cell of the UE.
Clause 14. The method of any of clauses 12 to 13, wherein a signal strength of the different cell is within a threshold of a signal strength of the serving cell of the UE.
Clause 15. The method of any of clauses 1 to 14, further comprising: transmitting, to the location server, before expiration of the threshold period of time, a second positioning request to obtain the position of the UE based on a positioning procedure for a different subscription of the UE than a subscription of the UE for which the first positioning request is transmitted.
Clause 16. The method of any of clauses 1 to 15, wherein the first positioning procedure is: an enhanced cell identifier (E-CID) positioning procedure, an over-the-top (OTT)-based positioning procedure, or a wireless local area network (WLAN)-based positioning procedure.
Clause 17. A user equipment (UE), comprising: one or more memories; one or more transceivers; and one or more processors communicatively coupled to the one or more memories and the one or more transceivers, the one or more processors, either alone or in combination, configured to: transmit, via the one or more transceivers, to a location server, a first positioning request to obtain a position of the UE based on a first positioning procedure involving at least a serving cell of the UE; receive, via the one or more transceivers, from the location server, an error message indicating that the position of the UE is not available; and transmit, to the location server, after expiration of at least a threshold period of time, a further positioning request to obtain the position of the UE based on a subsequent positioning procedure involving at least the serving cell of the UE, wherein the threshold period of time is based on occurrence of one or more conditions.
Clause 18. The UE of clause 17, wherein the error message includes one or more error reasons indicating: the serving cell of the UE was not found in a base station almanac (BSA) available to the location server, an operating frequency channel of the serving cell of the UE is not available in the BSA, an operating frequency of the serving cell of the UE is not available in the BSA, a network operator of the serving cell of the UE is not available in the BSA, no BSA is available for a region including the serving cell of the UE, or any combination thereof.
Clause 19. The UE of any of clauses 17 to 18, wherein the one or more conditions comprise: a change in serving cell of the UE, a change in an operating frequency channel of the UE, a change in an operating frequency of the UE, a change in network operator of the UE, an expiration of a timer, or any combination thereof.
Clause 20. The UE of any of clauses 17 to 19, wherein the one or more processors, either alone or in combination, are further configured to: receive, via the one or more transceivers, from the location server, one or more backoff rules for refraining from transmitting further positioning requests for at least the threshold period of time, wherein the one or more backoff rules indicate the one or more conditions.
Clause 21. The UE of clause 20, wherein: the one or more backoff rules are specific to different types of positioning methods, or the one or more backoff rules are common to different types of positioning methods.
Clause 22. The UE of any of clauses 17 to 21, wherein the one or more processors, either alone or in combination, are further configured to: receive, via the one or more transceivers, a broadcast of one or more system information blocks, wherein the one or more system information blocks include positioning barring information.
Clause 23. The UE of clause 22, wherein the positioning barring information includes the one or more conditions.
Clause 24. The UE of any of clauses 17 to 23, wherein the one or more conditions comprise: an expiration of a timer indicating that a previous position fix of the UE is valid, a positioning uncertainty of the previous position fix of the UE being greater than a threshold, or any combination thereof.
Clause 25. The UE of clause 24, wherein the positioning uncertainty of the previous position fix of the UE is based on a positioning uncertainty propagation model.
Clause 26. The UE of clause 25, wherein the positioning uncertainty propagation model is: a linear model, a quadratic model, a linear function, or a non-linear function.
Clause 27. The UE of any of clauses 25 to 26, wherein the positioning uncertainty propagation model is based on a motion classification of the UE.
Clause 28. The UE of any of clauses 17 to 27, wherein the one or more processors, either alone or in combination, are further configured to: transmit, via the one or more transceivers, to the location server, before expiration of the threshold period of time, a second positioning request to obtain the position of the UE based on a positioning procedure involving at least a different cell than the serving cell of the UE.
Clause 29. The UE of clause 28, wherein the different cell operates at a different operating frequency than an operating frequency of the serving cell of the UE.
Clause 30. The UE of any of clauses 28 to 29, wherein a signal strength of the different cell is within a threshold of a signal strength of the serving cell of the UE.
Clause 31. The UE of any of clauses 17 to 30, wherein the one or more processors, either alone or in combination, are further configured to: transmit, via the one or more transceivers, to the location server, before expiration of the threshold period of time, a second positioning request to obtain the position of the UE based on a positioning procedure for a different subscription of the UE than a subscription of the UE for which the first positioning request is transmitted.
Clause 32. The UE of any of clauses 17 to 31, wherein the first positioning procedure is: an enhanced cell identifier (E-CID) positioning procedure, an over-the-top (OTT)-based positioning procedure, or a wireless local area network (WLAN)-based positioning procedure.
Clause 33. A user equipment (UE), comprising: means for transmitting, to a location server, a first positioning request to obtain a position of the UE based on a first positioning procedure involving at least a serving cell of the UE; means for receiving, from the location server, an error message indicating that the position of the UE is not available; and means for transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.
Clause 34. The UE of clause 33, wherein the error message includes one or more error reasons indicating: the serving cell of the UE was not found in a base station almanac (BSA) available to the location server, an operating frequency channel of the serving cell of the UE is not available in the BSA, an operating frequency of the serving cell of the UE is not available in the BSA, a network operator of the serving cell of the UE is not available in the BSA, no BSA is available for a region including the serving cell of the UE, or any combination thereof.
Clause 35. The UE of any of clauses 33 to 34, wherein the one or more conditions comprise: a change in serving cell of the UE, a change in an operating frequency channel of the UE, a change in an operating frequency of the UE, a change in network operator of the UE, an expiration of a timer, or any combination thereof.
Clause 36. The UE of any of clauses 33 to 35, further comprising: means for receiving, from the location server, one or more backoff rules for refraining from transmitting further positioning requests for at least the threshold period of time, wherein the one or more backoff rules indicate the one or more conditions.
Clause 37. The UE of clause 36, wherein: the one or more backoff rules are specific to different types of positioning methods, or the one or more backoff rules are common to different types of positioning methods.
Clause 38. The UE of any of clauses 33 to 37, further comprising: means for receiving a broadcast of one or more system information blocks, wherein the one or more system information blocks include positioning barring information.
Clause 39. The UE of clause 38, wherein the positioning barring information includes the one or more conditions.
Clause 40. The UE of any of clauses 33 to 39, wherein the one or more conditions comprise: an expiration of a timer indicating that a previous position fix of the UE is valid, a positioning uncertainty of the previous position fix of the UE being greater than a threshold, or any combination thereof.
Clause 41. The UE of clause 40, wherein the positioning uncertainty of the previous position fix of the UE is based on a positioning uncertainty propagation model.
Clause 42. The UE of clause 41, wherein the positioning uncertainty propagation model is: a linear model, a quadratic model, a linear function, or a non-linear function.
Clause 43. The UE of any of clauses 41 to 42, wherein the positioning uncertainty propagation model is based on a motion classification of the UE.
Clause 44. The UE of any of clauses 33 to 43, further comprising: means for transmitting, to the location server, before expiration of the threshold period of time, a second positioning request to obtain the position of the UE based on a positioning procedure involving at least a different cell than the serving cell of the UE.
Clause 45. The UE of clause 44, wherein the different cell operates at a different operating frequency than an operating frequency of the serving cell of the UE.
Clause 46. The UE of any of clauses 44 to 45, wherein a signal strength of the different cell is within a threshold of a signal strength of the serving cell of the UE.
Clause 47. The UE of any of clauses 33 to 46, further comprising: means for transmitting, to the location server, before expiration of the threshold period of time, a second positioning request to obtain the position of the UE based on a positioning procedure for a different subscription of the UE than a subscription of the UE for which the first positioning request is transmitted.
Clause 48. The UE of any of clauses 33 to 47, wherein the first positioning procedure is: an enhanced cell identifier (E-CID) positioning procedure, an over-the-top (OTT)-based positioning procedure, or a wireless local area network (WLAN)-based positioning procedure.
Clause 49. A non-transitory computer-readable medium storing computer-executable instructions that, when executed by a user equipment (UE), cause the UE to: transmit, to a location server, a first positioning request to obtain a position of the UE based on a first positioning procedure involving at least a serving cell of the UE; receive, from the location server, an error message indicating that the position of the UE is not available; and transmit, to the location server, after expiration of at least a threshold period of time, a further positioning request to obtain the position of the UE based on a subsequent positioning procedure involving at least the serving cell of the UE, wherein the threshold period of time is based on occurrence of one or more conditions.
Clause 50. The non-transitory computer-readable medium of clause 49, wherein the error message includes one or more error reasons indicating: the serving cell of the UE was not found in a base station almanac (BSA) available to the location server, an operating frequency channel of the serving cell of the UE is not available in the BSA, an operating frequency of the serving cell of the UE is not available in the BSA, a network operator of the serving cell of the UE is not available in the BSA, no BSA is available for a region including the serving cell of the UE, or any combination thereof.
Clause 51. The non-transitory computer-readable medium of any of clauses 49 to 50, wherein the one or more conditions comprise: a change in serving cell of the UE, a change in an operating frequency channel of the UE, a change in an operating frequency of the UE, a change in network operator of the UE, an expiration of a timer, or any combination thereof.
Clause 52. The non-transitory computer-readable medium of any of clauses 49 to 51, further comprising computer-executable instructions that, when executed by the UE, cause the UE to: receive, from the location server, one or more backoff rules for refraining from transmitting further positioning requests for at least the threshold period of time, wherein the one or more backoff rules indicate the one or more conditions.
Clause 53. The non-transitory computer-readable medium of clause 52, wherein: the one or more backoff rules are specific to different types of positioning methods, or the one or more backoff rules are common to different types of positioning methods.
Clause 54. The non-transitory computer-readable medium of any of clauses 49 to 53, further comprising computer-executable instructions that, when executed by the UE, cause the UE to: receive a broadcast of one or more system information blocks, wherein the one or more system information blocks include positioning barring information.
Clause 55. The non-transitory computer-readable medium of clause 54, wherein the positioning barring information includes the one or more conditions.
Clause 56. The non-transitory computer-readable medium of any of clauses 49 to 55, wherein the one or more conditions comprise: an expiration of a timer indicating that a previous position fix of the UE is valid, a positioning uncertainty of the previous position fix of the UE being greater than a threshold, or any combination thereof.
Clause 57. The non-transitory computer-readable medium of clause 56, wherein the positioning uncertainty of the previous position fix of the UE is based on a positioning uncertainty propagation model.
Clause 58. The non-transitory computer-readable medium of clause 57, wherein the positioning uncertainty propagation model is: a linear model, a quadratic model, a linear function, or a non-linear function.
Clause 59. The non-transitory computer-readable medium of any of clauses 57 to 58, wherein the positioning uncertainty propagation model is based on a motion classification of the UE.
Clause 60. The non-transitory computer-readable medium of any of clauses 49 to 59, further comprising computer-executable instructions that, when executed by the UE, cause the UE to: transmit, to the location server, before expiration of the threshold period of time, a second positioning request to obtain the position of the UE based on a positioning procedure involving at least a different cell than the serving cell of the UE.
Clause 61. The non-transitory computer-readable medium of clause 60, wherein the different cell operates at a different operating frequency than an operating frequency of the serving cell of the UE.
Clause 62. The non-transitory computer-readable medium of any of clauses 60 to 61, wherein a signal strength of the different cell is within a threshold of a signal strength of the serving cell of the UE.
Clause 63. The non-transitory computer-readable medium of any of clauses 49 to 62, further comprising computer-executable instructions that, when executed by the UE, cause the UE to: transmit, to the location server, before expiration of the threshold period of time, a second positioning request to obtain the position of the UE based on a positioning procedure for a different subscription of the UE than a subscription of the UE for which the first positioning request is transmitted.
Clause 64. The non-transitory computer-readable medium of any of clauses 49 to 63, wherein the first positioning procedure is: an enhanced cell identifier (E-CID) positioning procedure, an over-the-top (OTT)-based positioning procedure, or a wireless local area network (WLAN)-based positioning procedure.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A user equipment (UE), comprising:
one or more memories;
one or more transceivers; and
one or more processors communicatively coupled to the one or more memories and the one or more transceivers, the one or more processors, either alone or in combination, configured to:
transmit, via the one or more transceivers, to a location server, a first positioning request to obtain a position of the UE based on a first positioning procedure involving at least a serving cell of the UE;
receive, via the one or more transceivers, from the location server, an error message indicating that the position of the UE is not available; and
transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

2. The UE of claim 1, wherein the error message includes one or more error reasons indicating:
the serving cell of the UE was not found in a base station almanac (BSA) available to the location server,
an operating frequency channel of the serving cell of the UE is not available in the BSA,
an operating frequency of the serving cell of the UE is not available in the BSA,
a network operator of the serving cell of the UE is not available in the BSA,
no BSA is available for a region including the serving cell of the UE, or
any combination thereof.

3. The UE of claim 1, wherein the one or more conditions comprise:
a change in serving cell of the UE,
a change in an operating frequency channel of the UE,
a change in an operating frequency of the UE,
a change in network operator of the UE,
an expiration of a timer, or
any combination thereof.

4. The UE of claim 1, wherein the one or more processors, either alone or in combination, are further configured to:
receive, via the one or more transceivers, from the location server, one or more backoff rules for refraining from transmitting further positioning requests for at least the threshold period of time, wherein the one or more backoff rules indicate the one or more conditions.

5. The UE of claim 4, wherein:
the one or more backoff rules are specific to different types of positioning methods, or
the one or more backoff rules are common to different types of positioning methods.

6. The UE of claim 1, wherein the one or more processors, either alone or in combination, are further configured to:
receive, via the one or more transceivers, a broadcast of one or more system information blocks, wherein the one or more system information blocks include positioning barring information.

7. The UE of claim 6, wherein the positioning barring information includes the one or more conditions.

8. The UE of claim 1, wherein the one or more conditions comprise:
an expiration of a timer indicating that a previous position fix of the UE is valid,
a positioning uncertainty of the previous position fix of the UE being greater than a threshold, or
any combination thereof.

9. The UE of claim 8, wherein the positioning uncertainty of the previous position fix of the UE is based on a positioning uncertainty propagation model.

10. The UE of claim 9, wherein the positioning uncertainty propagation model is:
a linear model,
a quadratic model,
a linear function, or
a non-linear function.

11. The UE of claim 9, wherein the positioning uncertainty propagation model is based on a motion classification of the UE.

12. The UE of claim 1, wherein the one or more processors, either alone or in combination, are further configured to:
transmit, via the one or more transceivers, to the location server, before expiration of the threshold period of time, a second positioning request to obtain the position of the UE based on a positioning procedure involving at least a different cell than the serving cell of the UE.

13. The UE of claim 12, wherein the different cell operates at a different operating frequency than an operating frequency of the serving cell of the UE.

14. The UE of claim 12, wherein a signal strength of the different cell is within a threshold of a signal strength of the serving cell of the UE.

15. The UE of claim 1, wherein the one or more processors, either alone or in combination, are further configured to:
transmit, via the one or more transceivers, to the location server, before expiration of the threshold period of time, a second positioning request to obtain the position of the UE based on a positioning procedure for a different subscription of the UE than a subscription of the UE for which the first positioning request is transmitted.

16. The UE of claim 1, wherein the first positioning procedure is:
an enhanced cell identifier (E-CID) positioning procedure,
an over-the-top (OTT)-based positioning procedure, or
a wireless local area network (WLAN)-based positioning procedure.

17. A method of wireless communication performed by a user equipment (UE), comprising:
transmitting, to a location server, a first positioning request to obtain a position of the UE based on a first positioning procedure involving at least a serving cell of the UE;
receiving, from the location server, an error message indicating that the position of the UE is not available; and
transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.

18. The method of claim 17, wherein the error message includes one or more error reasons indicating:
the serving cell of the UE was not found in a base station almanac (BSA) available to the location server,
an operating frequency channel of the serving cell of the UE is not available in the BSA,
an operating frequency of the serving cell of the UE is not available in the BSA,
a network operator of the serving cell of the UE is not available in the BSA,
no BSA is available for a region including the serving cell of the UE, or
any combination thereof.

19. The method of claim 17, wherein the one or more conditions comprise:
a change in serving cell of the UE,
a change in an operating frequency channel of the UE,
a change in an operating frequency of the UE,
a change in network operator of the UE,
an expiration of a timer, or
any combination thereof.

20. A user equipment (UE), comprising:
means for transmitting, to a location server, a first positioning request to obtain a position of the UE based on a first positioning procedure involving at least a serving cell of the UE;
means for receiving, from the location server, an error message indicating that the position of the UE is not available; and
means for transmitting, to the location server, after expiration of at least a threshold period of time, a further positioning request to obtain the position of the UE based on a subsequent positioning procedure involving at least the serving cell of the UE, wherein the threshold period of time is based on occurrence of one or more conditions.
